(19) United States
(12) Patent Application Publication
(10) Pub. No.: US 2026/0327114 A1
(43) Pub. Date: Oct. 22, 2026

(54) A LOW-POWER SYSTEM AND METHOD FOR REMOVAL OF AMMONIA AND DISINFECTION OF SEA WATER FOR IMPROVED FISH HEALTH AND VALUE

(71) Applicant: CURRENT WATER TECHNOLOGIES INC., Guelph (CA)

(72) Inventors: INGELSSON Markus, Milton (CA); SHELP Gene, Guelph (CA)

(21) Appl. No.: 19/111,401

(22) PCT Filed: Sep. 13, 2023
(86) PCT No.: PCT/CA2023/051218

§ 371 Date: Mar. 13, 2025

Related U.S. Application Data
(60) Provisional application No. 63/375,466, filed on Sep. 13, 2022.

(51) Int. Cl. C02F 9/00; C02F 1/00; C02F 1/20; C02F 1/28; C02F 1/461; C02F 1/467; C02F 1/70; C02F 101/16; C02F 103/08; C02F 103/20

(52) U.S. Cl. CPC C02F 9/00; C02F 1/004; C02F 1/20; C02F 1/281; C02F 1/283; C02F 1/46109; C02F 2001/46142; C02F 1/4672; C02F 1/70; C02F 2101/16; C02F 2103/08; C02F 2103/20; C02F 2201/004; C02F 2201/4617; C02F 2209/02; C02F 2303/04; C02F 2303/20

(57) ABSTRACT

An efficient and scalable system is disclosed for the destruction of viruses, bacteria, fungal spores, micro-zooplankton; along with the removal of ammonia to meet the physiological requirements for aquatic life; along with the prevention of biofilm formations; and the removal of harmful algae species from salt water used to support salt water aquatic life. The system is well suited for use in recirculating aquaculture systems, fish storage facilities, mobile temporary storage, live haul fish transport, fishing vessel holding tanks, hatcheries, well boats, aquariums, shrimp pond cultures, commercial fish retail outlets, and seafood distribution centers.

### TECHNICAL FIELD

The present disclosure pertains to a highly efficient electrochemical based treatment system and method for the removal of total aqueous ammonia (defined as ammonia+ammonium), and simultaneous disinfection of salt water containing bacteria, viruses, protozoan, fungal spores, micro-zooplankton, and harmful algae species; and the prevention of biofilm formations. Electrochemical based water treatment system refers to the application of multiple devices in concert, one being capable of generating electrical current via the submergence of electrodes to facilitate electrochemical reactions in salt water and another simultaneously capable of removing the residual chemical by-products of the electrochemical reactions. The resulting synergistic actions of the different system devices creates a healthy aquatic environment for sea animals during live transport to market, storage and during production.

### BACKGROUND

A critical part of the aquaculture value chain is the removal of ammonia and the disinfection of salt water. The ability to remove ammonia and disinfect water affects aquatic life health and meat quality. It is also required to enable extended-duration transportation of live fish to market, as opposed to frozen fish. Each of these is critical to the economic value for the fish.

Many strategies exist for ammonia removal from seawater supporting aquatic life. One common approach involves de-nitrification bio-filters where bacteria ingest and break down ammonia. One problem with these systems is maintaining the health of the bacteria. If the fish are removed from the system for a few days, the bacteria lack food (ammonia) and die. Then the bacteria must be recharged, which requires a 7-day period. A further problem with this system is that it doesn't provide disinfection. Hence, there is a risk of a rapidly spreading disease if the water becomes contaminated. A further disinfection issue in international aquatic life transport concerns the ability to replace the water after delivering a given load prior to taking on a new load for transport. International regulations require proof of disinfection to dump water that originates from another jurisdiction. As a result, these systems are not preferred for international transport.

An alternative to bio-filter systems involves using salt-water generators along with some form of filtration. These systems are well-known for their use in maintaining water quality in salt-water pools. A salt-water generator is a relatively high-voltage and high-power device which serves to remove ammonia, and produces diatomic chlorine (Cl₂) from chloride, which is a critical part of the process to oxidize pathogens within the water.

It is desirable to have a low-voltage and more energy efficient, continuous, flow-through recirculation-based electrolysis system which is completely scalable by which contaminated water is bled from the fish tank, treated, and filtered prior to being returned to the fish tank such that no free or combined chlorine is returned to the tank. For animal transport applications, the system must be designed to operate problem-free in order to ensure the safe transport of live aquatic animals from the location of origin to the location of delivery. Furthermore, this approach is designed to ensure the delivery of healthy, high value animals with little/no mortality.

### BRIEF DESCRIPTION OF THE DRAWINGS

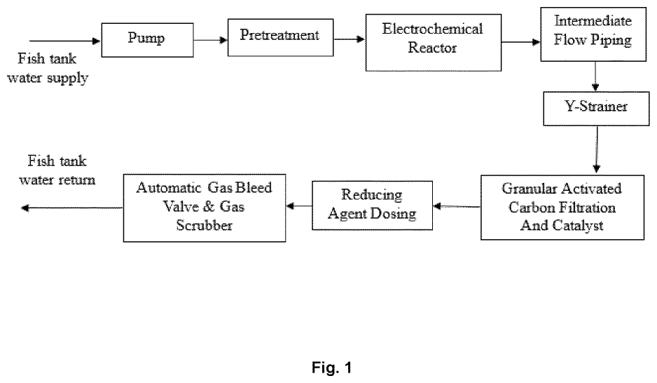

For a better understanding of the nature and objects of the embodiments of the present disclosure, reference should be made to the detailed description taken in conjunction with the accompanying drawings wherein:
(a) FIG. 1 is a schematic diagram illustrating a low-power system for removal of ammonia and disinfection of sea water for improved fish health and value in accordance with one embodiment of the present disclosure.

### DETAILED DESCRIPTION OF PARTICULAR EMBODIMENTS

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways.

Also, it is to be understood that the phraseology and terminology employed herein are for the purpose of description and should not be regarded as limiting. In particular, all terms used herein are used in accordance with their ordinary meanings unless the context or definition clearly indicates otherwise. Also, unless indicated otherwise except within the claims the use of “or” includes “and” and vice-versa. Non-limiting terms are not to be construed as limiting unless expressly stated or the context clearly indicates otherwise (for example, “including”, “having”, “characterized by” and “comprising” typically indicate “including without limitation”). Singular forms included in the claims such as “a”, “an” and “the” include the plural reference unless expressly stated or the context clearly indicates otherwise. As used herein, “substantially” means sufficient to function for its intended purpose. As such, the term “substantially” means a small, insignificant amount from absolute or perfect conditions, dimensions, measurements, results, etc., as would be expected by one skilled in the art, but which does not significantly affect overall performance, and allows for variation. “Substantially” when used for a number or parameter or property that can be expressed as a number means within 10 to 15 percent. Further, the stated features and/or configurations or embodiments thereof the suggested intent may be applied as seen fit to certain operating conditions or environments by one experienced in the field of art.

The following is the schematic for one embodiment of the present invention, which is followed by an explanation of the function of each schematic component identified in FIG. 1.

### Pump:

While a variety of pumps and pump control technologies can be utilized, the preferred approach involves using a variable frequency drive positive-displacement pump to establish the flow rate through the system.

### Pretreatment:

The water entering the reactor must be pretreated to remove chemical constituents in the fish tank water supply that may deleteriously interfere with the efficacy of the electrochemical reactor and the de-chlorinating capacity of the granular activated carbon media. Required pretreatment equipment constitutes, but is not limited to, a foam separating device, a multimedia filtration device, and additional filtration equipment.

The specific pretreatment objective is to remove suspended or dissolved organic carbon material, and suspended inorganic material, that can deleteriously interfere with the reaction kinetics within the electrochemical reactor embodiment and/or be adsorbed to the activated carbon media, which may diminish its dechlorinating capacity over time. Adsorption of organic and inorganic material on the granular activated carbon reduces the active surface area that is otherwise available to catalyze the reduction of free chlorine to chloride. Proper pretreatment of the fish tank water supply will enable the electrochemical reactor and granular activated carbon to be maintained in pristine condition, hence reducing the demand for frequent cleaning and replacement. In addition, proper pretreatment of the source water using the aforementioned equipment at the point of origin for transport applications, or at the site of a stationary installation, is imperative prior to commencing the operation of the present invention.

### Electrochemical Reactor:

The reactor is optimized for use in a highly electrically conductive environment such as with ocean water, and requires between 2V and 8V.

Key chemical reactions at the reactor:

2NH₄⁺→N₂+8H⁺+6e⁻

2 Cl⁻→Cl₂+2e⁻

[Catalyst][Organic compound: XXXX]→CO₂+[Oxidized Organic compound: XXXXO]+e⁻

### Intermediate Flow Piping:

Away from the reactor, the following chemical reactions occur:

CL₂+H₂O→HOCl+H⁺+Cl⁻ a.

2NH4⁺+3HOCl→N₂+3H₂O+5H⁺+3Cl⁻; ammonium not oxidized at the reactor's electrodes is oxidized via chlorine b.

HOCl+[dirt, pathogens, etc.]→HCl+[oxidized direct, pathogens: XXXXO]

A Y-strainer with a screen size of, but not limited to, 1/32″ is placed immediately downstream of the reactor to remove large flakes of precipitated salt that may form, and consequently released into the water stream, within the embodiment of the reactor during system operation.

### Granular Activated Carbon Filtration and Catalyst:

The granular activated carbon catalyst column may be a single column or be split into a group of parallel columns to minimize flow resistance through the system.

The granular activated carbon is pretreated with acid to prevent it from affecting the pH of the water stream. In addition, the granular activated carbon is “hydro-sieved” using a 500 μm screen to remove fine particles to avoid clogging and to increase the hydraulic conductivity of the media.

The column ends will include perforated screens to contain the activated carbon.

In larger, more sophisticated systems, the columns may include pressure drop sensors to monitor when the activated carbon media should be regenerated. In addition, isolation valves may be placed at the input and output of each column to enable columns to be isolated and taken out of operation for service.

The following chemical reaction occurs at the activated carbon catalyst: HOCl+H⁺→H₂O +Cl⁻

Activated carbon collects XXXXO and suspended solids.

### Dosing of Reducing Agent Chemical:

Following the granular activated carbon filter, a chemical reducing agent dosing system is incorporated as a redundancy measure to ensure that no chlorine residual is present in the fish tank water return (i.e., the treated water effluent). Chlorine, in any concentration, is highly toxic to fish. Such chemical reducing agents include, but are not limited to, Sodium Sulfite (Na₂SO₃), Sodium Bisulfite (NaHSO₃), Sodium Metabisulfite (Na₂S₂O₅), Sodium Hydrosulfite (Na₂S₂O₄), Sodium Thiosulfate (Na₂S₂O3), or Ascorbic Acid (C₆H₈O₆). The chemical reducing agent is typically dosed as a liquid solution using a metered dosing pump, but can also be added as a salt.

Chemical reducing agent dosing can be achieved by installing an in-line liquid injector followed by an in-line static mixer into the piping system. The chemical reducing agent can be added to an intermediate buffer or flow equalization tank. Alternatively, a large solid salt block containing any of the aforementioned chemical reducing agents can also be placed in an in-line cartridge. Consequently, the process water is allowed to flow over the salt block, which permits the slow release of the chemical reducing agent over time.

The reducing agent dosing system can be set to a pre-defined dosing rate/schedule, or be controlled by a more sophisticated automated control system where dosing is activated based on a sensor signal measuring free chlorine in the effluent from the granular activated carbon filters.

### Automatic Gas Bleed Valve & Gas Scrubber:

Hydrogen, nitrogen gas, and any other gases present in the water, are removed from the water stream and vented to, but not limited to, the atmosphere.

This system can operate under fixed, continuously recirculating flow driven by a simple on-off switch, or via a remote monitoring and control system with alarms and notifications as needed. The monitoring system will typically involve the Electrochemical Reactor and VFD pump, but as described above, may also involve monitoring the service requirements of the activated carbon filtration and catalyst columns.

Control of the pump and reactor will involve the monitoring of ammonium concentration, water flow rate, and the reactor voltage and amperage. Alarms with notifications for these parameters can then be set based on minimum and maximum operating set points to indicate possible malfunctions relative to the pump or reactor.

Assuming the pump and reactor are functioning properly, control is tied to the reactor, which is specifically designed to treat X mg of ammonium per second based on a fixed voltage and current at the reactor. The size of X is set to be some amount greater than (the maximum anticipated ammonium per liter) * (maximum system flow rate, liter/sec). The purpose of this is to enable the ammonium to be treated and provide sufficient additional oxidation capacity for treating various pathogens entrained in the water. In this way, an optimal control system may be engaged to ensure ammonium levels are kept below a given set point while minimizing the flow rate through the system to minimize operating cost.

Different aquatic species may release different quantities of ammonia into the water, and it is imperative to calibrate the system to whatever species is being handled. In addition, a more sophisticated optimal control system can be engaged to control both flow rate and reactor current to further minimize operating cost.

### Data:

A test was conducted involving a generic water tank connected to a 2-HP VFD-controlled pump leading to a 3-inch diameter electrochemical reactor, which was followed by a length of intermediate piping to feed granular activated carbon columns, leading to a gas bleed valve with the water flowing to a second generic water tank. At the start of the trial, the input water tank had total ammonia nitrogen (TAN) of 250 mcg/L with no detectable chloramines, nitrates, or free chlorine, and the water temperature was 25 °C. During the trial, the flow rate through the reactor was set at 14 GPM (53 LPM). At the conclusion of the trial, the TAN, chloramines, nitrates, and free chlorine for the water in the output tank were all non-detectable, demonstrating 100% removal of the TAN and no hazardous byproducts.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, functions, operations, or steps, any of these embodiments may include any modification, combination or permutation of any of the components, elements, functions, operations, or steps described or illustrated anywhere herein that a person having ordinary skill in the art would comprehend. All such modifications, combinations and permutations are believed to be within the sphere and scope of the invention as defined by the claims appended hereto.

We claim:

1. The AmmEL-Aqua system is comprised of the following main components: a pretreatment/prefiltration sequence, an electrochemical apparatus, a strainer, an activated carbon apparatus, and a chemical dosing system.

2. The method of claim 1 includes a pretreatment sequence, wherein:
a. The fish tank water feed passes through a device that removes foam and larger suspended particles from the water;
b. The fish tank water feed passes through a media filtration device consisting of a silica-based material, which can be, but is not limited to, activated glass filtration media or granular activated carbon; and
c. The fish tank water feed passes through a single, or a series, of filters that remove suspended particles.

3. The method of claim 1 includes an electrochemical apparatus for converting aqueous ammonia into innocuous nitrogen gas, while disinfecting the salt water, wherein:
a. The anode and cathode of the electrochemical apparatus are constructed of chemically resistant materials such as titanium;
b. The cathode forms the outer structural surface of the electrochemical apparatus;
c. The anode forms the inner structural surface of the electrochemical apparatus;
d. Highly electrically conductive solution ammonia containing, such as, but not limited to, ocean water and salt brines are used as the electrolyte of the electrochemical apparatus;
e. The electrolyte passes between the anode and cathode surfaces of the electrochemical apparatus where it is oxidized using a dimensionally stable anode (DSA), comprised of, but not limited to, a ruthenium, iridium and tin coating on a titanium anode substrate;
f. The oxidized compounds will convert ammonia into an environmentally friendly gas, N₂;
g. The oxidized compounds will kill bacteria, virus, pathogens (micro-zooplankton), and fungal spores, and prevent biofilm formations;
h. The anode and the cathode of the electrochemical apparatus is connected to a DC power supply through external electrical connections;
i. The reactor is connected to other components of the apparatus by chemically resistant flanges and gaskets. The gaskets are placed between the flanges to ensure that the reactor is water and air tight. The flanges are secured with threaded rods, and nuts;
j. The catalytic conversion of ammonia to nitrogen gas takes place in the electrolyte, where nitrogen gas is exhausted to the atmosphere upon the discharge of the reactor; and
k. The reactor will be connected to an external DC power supply, and between 2-8 volts will be applied to each cell with each cell operated at current densities of 10-400 A m⁻².

4. The method of claim 1 includes the positioning of a strainer following the electrochemical apparatus, wherein:
a. The strainer will effectively remove large precipitate and suspended matter from the electrolyte.

5. The method of claim 1 includes the positioning of an activated carbon apparatus following the strainer to facilitate the continued reuse of the electrolyte, wherein:
a. The activated carbon has been pretreated with acid to maintain a neutral pH during operation;
b. The activated carbon has been pretreated to remove particles less than 500 μm in size;
c. The activated carbon apparatus will convert residual oxidized aqueous compounds derived from the electrolyte back to their original state; and
d. The activated carbon apparatus may remove total dissolved and suspended organic compounds and harmful algae from the electrolyte.

6. The method of claim 1 includes a chemical reducing agent dosing system following the activated carbon apparatus, wherein:
a. A chemical reducing agent, such as, but is not limited to, Sodium Thiosulfate, is added in liquid form to the water using an in-line injection system, is dosed to an open buffer or flow equalization tank, or is added to the water in a salt form.

7. The method of claim 1 includes operating between 0 °C and 25 °C, and with a pressure between 1-30 psi, wherein:
a. The temperature of the electrolyte may be controlled by a heating/cooling element; and
b. The method of claim 1 requires the pH of the electrolyte to remain above 4 to avoid chlorine gas evolution, and to maintain high conversion efficiency of ammonia.

8. The method of claim 1 requires proper pretreatment of the source water at the location of origin for animal transport applications, wherein:
a. Pretreatment equipment constitutes, but is not limited to, a foam separating device, a multimedia filtration device, additional filtration equipment, and/or an additional stationary AmmEL-Aqua ammonia treatment system.
